(19) United States
(12) Patent Application Publication
(10) Pub. No.: US 2017/0188216 A1
(43) Pub. Date: Jun. 29, 2017

(54) PERSONAL EMERGENCY SAVER SYSTEM AND METHOD

(71) Applicants: AMOTZ Koskas, Tel Aviv (IL); Alex Rivkin, Pardes Hana (IL)

(72) Inventors: AMOTZ Koskas, Tel Aviv (IL); Alex Rivkin, Pardes Hana (IL)

(21) Appl. No.: 15/390,152

(22) Filed: Dec. 23, 2016

(30) Foreign Application Priority Data
Dec. 27, 2015 (IL) 243358

(51) Int. Cl. H04W 4/22; H04W 4/02; G08B 25/01

(52) U.S. Cl. CPC H04W 4/22; G08B 25/016; H04W 4/025

(57) ABSTRACT

The present invention relates to a personal emergency saver system or device, in particular for persons carrying mobile communication devices, and a method for using the device or system in order to obtain assistance in emergency situations.

### FIELD OF THE INVENTION

The present invention relates to a personal emergency saver, in particular for personals carrying mobile communication devices.

### BACKGROUND OF THE INVENTION

People often carry mobile communication devices, such as Smart phones where ever they go. Many emergency situations may come across people and it is crucial to request and receive help as soon as possible. Sometimes, a person who needs help uses his Smartphone to initiate call(s) to individual(s) or emergency services to come rescue him. In some emergency situations, the person is unable to operate a mobile communication device or doesn't have time to contact or call someone for help or he lacks awareness of the upcoming danger. In such cases, an automatic call is sent to individual(s) or emergency services to come rescue the person in an emergency situation.

Such issues for placing an automatic call or initiating a call to a third party in emergency situations using a personal mobile communication device are addressed for example in U.S. Pat. No. 8,929,853, US 20140074504, U.S. Pat. No. 8,111,154, WO2015126348, WO 2015014075, KR20140007118 and KR20070080537.

U.S. Pat. No. 8,929,853, discloses a mobile communication device that in certain events can cause the device to summon assistance automatically. For example, while the device is in an attack detection mode, if the device's user ceases to interact with the device, then the device can automatically place a telephone call to emergency services (e.g., by calling 911). For another example, while the device is in an attack detection mode, similarly in case an accelerometer contained within, the device detects a sudden shock, then the device can automatically place a telephone call to emergency services. After detecting a probable emergency situation, the mobile device can responsively and continuously emit a loud audible alarm through the device's speakers at maximum volume regardless of the device's current silence or volume settings, in an effort to attract help from other people who may be nearby.

US 2014074504 discloses a method to monitor activity that includes monitoring a sensor activated by an individual. The method also includes recording activation of the sensor, determining a behavior routine of the individual based on recorded activations of the sensor and analyzing the recorded sensor activations to determine a behavior routine. The method also includes identifying a change in the behavior routine based on the analysis of the recorded sensor activations.

U.S. Pat. No. 8,111,154 discloses a computer-implemented method for monitoring a mobile-computing device using geo-location information. The method may include a learning phase. During the learning phase, a user may be located within a first range of physical locations during a recurring time period. The method may include generating a location profile for a mobile-computing device of the user and receiving a device-monitoring policy for the mobile computing device from an administrator. The location profile may correlate the first range of physical locations with the recurring time period. The method may further include detecting, after the learning phase that the mobile-computing device is outside the first range of physical locations during a first instance of the recurring time period. The method may also include implementing the device-monitoring policy after detecting that the mobile-computing device is outside the first range of physical locations during the first instance of the recurring time period.

WO2015126348 discloses locating systems that monitor people from many different groups, such as children, invalids, athletes (athletes who are active in the field of mountain climbing, skiing, trekking, etc.), works personnel and older people for different reasons. The properties of the system: consisting of a locating system that can be attached to the clothing and/or portable equipment of persons that consists of at least one sensor such as an acceleration sensor, a pressure sensor, a pulse sensor a biometric sensor and communicates via the GPS or GPRS module. The data coming from the locating system are stored in the personal data analysis unit and in the general data storage unit. Upon ascertainment of an emergency situation, the communication interface is used to contact at least one unit such as the health unit, the safety unit, the relatives to be informed and the occupational health and safety officer and the system contains at least one operator and/or at least one superior execution module of the procedure for emergency situations.

WO 2015014075 discloses a method and apparatus for an alarm for a mobile device. Said method includes storing the historical operating status data for the mobile device and/or the statistical analysis of the historical operating status data, and comparing the current operating status data of the mobile device with the stored historical operating status data and/or the statistical analysis of the historical operating status data to determine whether an abnormal event has occurred. The device will be switched into alarm mode if an abnormal event has occurred. Said method determines whether an abnormal event has occurred to the current status of the mobile device based on a user's daily habits, and the mobile device is switched into alarm mode if any abnormal event has occurred. Conditions for triggering an alarm are kept secret, which is particularly advantageous for alarms required in certain environments.

KR20140007118 discloses a security and emergency reporting device based on a smart phone to enable a user to make an emergency request under a situation where the user cannot operate a phone, by automatically sending a message or making an urgent call, which includes the current position, to a designated telephone number in case of a security and emergency situation in the surrounding area of the user by using various sensors and a smart phone comprising the same.

KR20070080537 discloses an automatic unusual action reporting device and a system thereof that reports the user's unusual action even if the user is unable to operate a cellular phone, by automatically transmitting information through the cellular phone, and to precisely judge the unusual action by using an acceleration sensor and a geomagnetic azimuth sensor. An automatic unusual action reporting device is composed of an action sensing unit sensing the user's action; an unusual action judging unit judging whether the user's action is unusual or not according to a judgment order by matching similarity of the action sensed by the action sensing unit with a preregistered unusual action pattern. An automatic reporting unit connected with a cellular phone, to report the unusual action to a pre-registered contact phone number by automatically operating the cellular phone if the unusual action judging unit determines that the user's action is unusual. An alarming unit outputting the alarm sound if the cellular phone is disconnected from the automatic reporting unit.

However, the above mentioned inventions and prior art fail to disclose a system that provides a full and detailed analysis and categorization of each kind of different emergency situation such that emergency centers worldwide will be able to be contacted immediately and directly by persons in need, with relevant structured reports, while minimizing false calls, calls to wrong emergency centers, language barriers, and other time consuming communication difficulties.

One of the objects of the present invention is to automatically categorize an emergency situation of a subscriber based on machine learning, big data analysis, cross checking and cross-referencing sensors data analysis and analyzing semantically words and sentences of the subscriber which could be in a message data or audio data in order to send as much as possible data and as accurate and detailed report to the relevant call-center(s) about the emergency situation and minimizing false positive reports.

Another object of the present invention is to exchange audio/message information between the subscriber communication device and a call-center regarding an emergency situation where one side in the communication can send its information in his desired language and where the second side receives the exchange audio/message information in his desired or local language.

Yet another object of the present invention is to provide a system and method for controlling manually or automatically the sensitivity of a subscriber protection. For example if the subscriber hitchhiking he can manual control the sensitivity of the subscriber's protection to a higher level of protection by using the application of the invention. When choosing a higher level of protection the monitoring intervals for example are shortened, more sensors of the communication device can be activated including voice recording and picture snap-shooting. Another example when the level of protection can be increased is when the subscriber is in abroad or when the subscriber is jogging in the streets at night. Other examples for when the system and method of the invention detects a dangerous geographic zone (or a dangerous time in said zone, i.e. night time in certain areas); it automatically increases the level of subscriber protection and monitoring.

Yet another object of the present invention is that the system and method of the present invention can learn the subscriber behavior by using machine learning for reducing for example false negative of emergency situations.

Other objects and advantages of the present invention are apparent in the following detailed description, appended claims and accompanying drawings.

### SUMMARY OF THE INVENTION

The present invention relates to a personal emergency saver, in particular for personals carrying mobile communication devices.

In accordance with an embodiment of the present invention there is provided a system for helping at least one individual in at least one emergency situation. The system includes one or more servers communicatively connected to one or more communication network. One or more wireless mobile communication devices of subscribers are having at least one sensor means in each of the communication devices. The wireless mobile communication device is communicatively connected through the communication network(s) with the server(s). One or more call-center (s) communicates with the server and the mobile communication device in an emergency situation. The server is communicatively connected with the communication device for identifying passively and automatically an abnormal and/or emergency situation regarding to a subscriber without the involving of the subscriber, the server further automatically call to the relevant emergency call-center(s) for helping the subscriber when an emergency situation is identified.

### BRIEF DESCRIPTION OF THE DRAWINGS

The invention may be understood upon reading of the following detailed description of non-limiting exemplary embodiments thereof, with reference to the following drawings, in which:

FIG. 1 is a schematic exemplary system according to an embodiment of the present invention;

FIG. 2 is an exemplary block diagram of a communication device in which the present invention can be implemented;

FIG. 3 is a an exemplary block diagram of modes of operations in accordance with some embodiments of the present invention;

FIG. 4 is a graph illustrating an exemplary accelerometer values in the x, y and z direction that is sampled every 5 seconds;

FIG. 5 is an exemplary schematic display message shown on the subscriber mobile communication device in accordance with one embodiment of the present invention; and

FIG. 6A-6E is a flowchart describing the method of the present invention in accordance with an exemplary preferred embodiment of the present invention.

The following detailed description of the invention refers to the accompanying drawings referred to above. Dimensions of components and features shown in the figures are chosen for convenience or clarity of presentation and are not necessarily shown to scale. Wherever possible, the same reference numbers will be used throughout the drawings and the following description to refer to the same and like parts.

### DETAILED DESCRIPTION OF EMBODIMENTS OF THE INVENTION

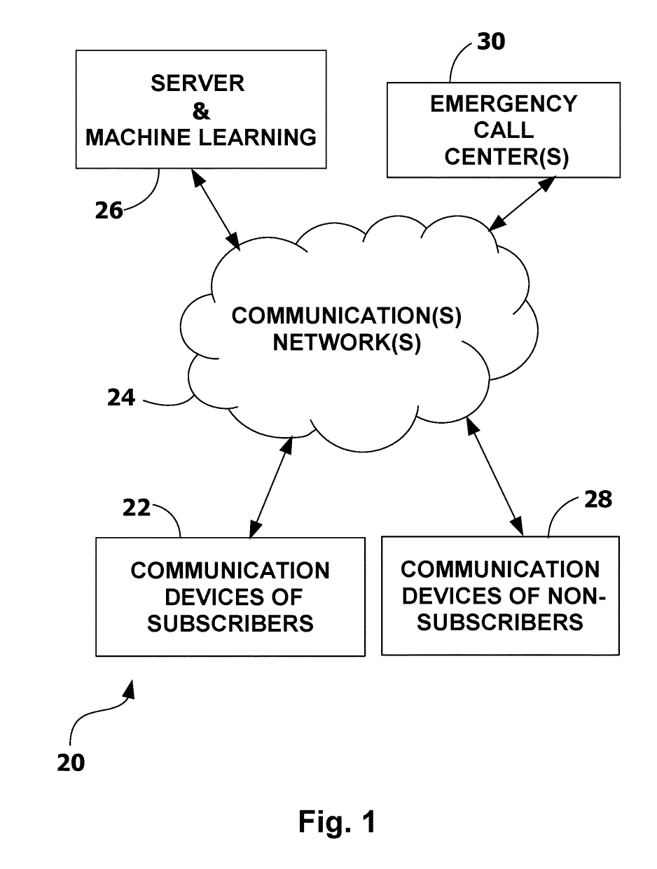

Referring first to FIG. 1, there is shown an exemplary system 20 in accordance with the present invention. A wireless mobile communication device(s) of subscriber(s) 22 such as but not limited to Smart phones, tablets and Smart watches are communicatively connected through a communication(s) network(s) 24 to one or more servers 26. A mobile communication device(s) of non-subscriber(s) 28 such as but not limited to Smart phones, tablets and Smart watches and personal computers are communicatively connected through a communication(s) network(s) 24 to one or more mobile communication device (s) of subscribers 22. Mobile communication device (s) of subscribers 22 runs a client application in accordance with the present invention which will be described later in detail. Server(s) 26 may run in accordance with the present invention a machine learning application which may include one or more databases which will be described later.

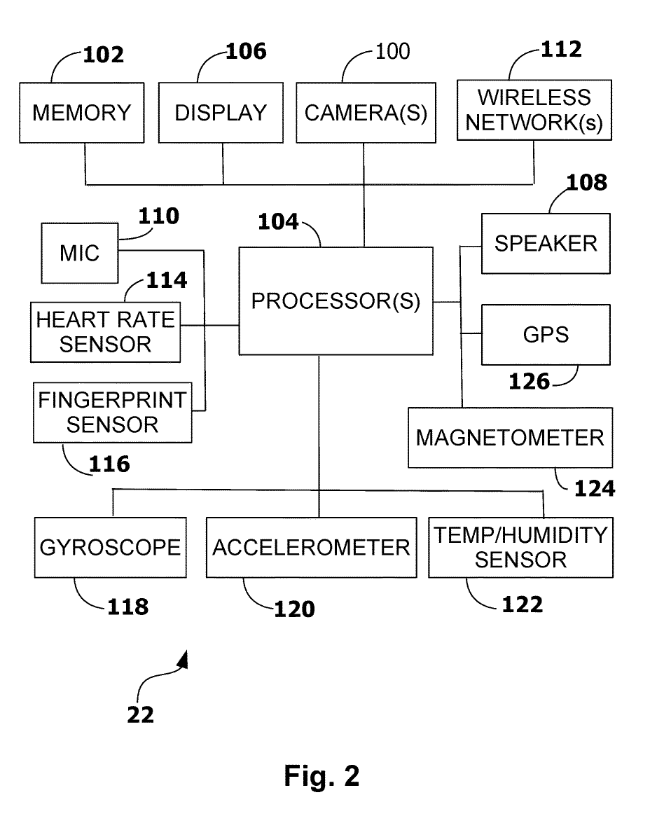

Referring to FIG. 2, the illustrated mobile communication device 22 includes a memory 102 to store for example software programs such as but not limited to the application of the invention and other data, which may include any suitable types of memory known in the art. During use, the software may be loaded from the memory 102. Mobile communication device 22 further includes, a processor 104 (or microcontroller, digital signal processes or other device that executes instructions) coupled to memory 102, a display 106, which may be regular or a touch screen type display, a speaker 108, a microphone 110, a wireless or other network unit 112 for connecting electrically, optically or wirelessly to the Internet or other network, other I/O interfaces such as universal serial bus (USB) interface or other I/O interfaces (not shown). The mobile communication device 22 may further includes one or more sensors such as but not limited to a heart rate sensor 114, a finger print sensor 116, a gyroscope 118, a barometric pressure sensor (not shown), an ambient pressure sensor (not shown), a UV sensor (not shown), an oxymetry sensor (not shown), a skin conductance sensor (not shown), a skin temperature sensor (not shown), accelerometer 120, a temperature/humidity sensor 122 and a magnetometer 124. The mobile communication device 22 may further include a global position system (GPS) 126 and any additional sensor which may interact or embedded in a communication device.

The program application of the invention that runs on mobile device 22 enables subscribers to actively report about an emergency situation for example by activating a predetermine widget using touch screen display 106 that notify server 20 through a communication(s) network(s) 24 about an emergency situation of a particular subscriber. If the emergency situation is relevant to other subscribes, server (s) (26) may also report them about the emergency situation. In accordance with some embodiments, system and method of the present invention can identify passively and automatically assert an emergency situation regarding to a certain subscriber without the involvement of the subscriber. For example, if a subscriber is involved in a serious car accident and he is injured badly and he is unable to pick up his mobile phone and call for an emergency service or a friend to help him, the system of the present invention can automatically identify and categorized the abnormal situation of the subscriber and can automatically call to the right emergency call-center 30 in this example, to the police and ambulance for helping the injured subscriber. In the call-center 30 could be an emergency officer, a certified person to handle and manage the emergency situation in real time. The emergency officer could be a cop, a fireman, an officer, or a municipality worker. The system in accordance of the present invention can provide information to the emergency call-center(s) 30 about the present situation of the subscriber and regarding to the abnormal event category and real time report from the subscriber's location, instead of the subscriber. An open communication line can be opened between the subscriber and the relevant emergency call-center(s) 30. For example, the microphone 110 and the recorded option of the subscriber communication device 22 will be activated in order to analyze the emergency situation. The speaker 108 and/or SMS/What's App message can be sending data automatically from the subscriber communication device 22 to server 26.

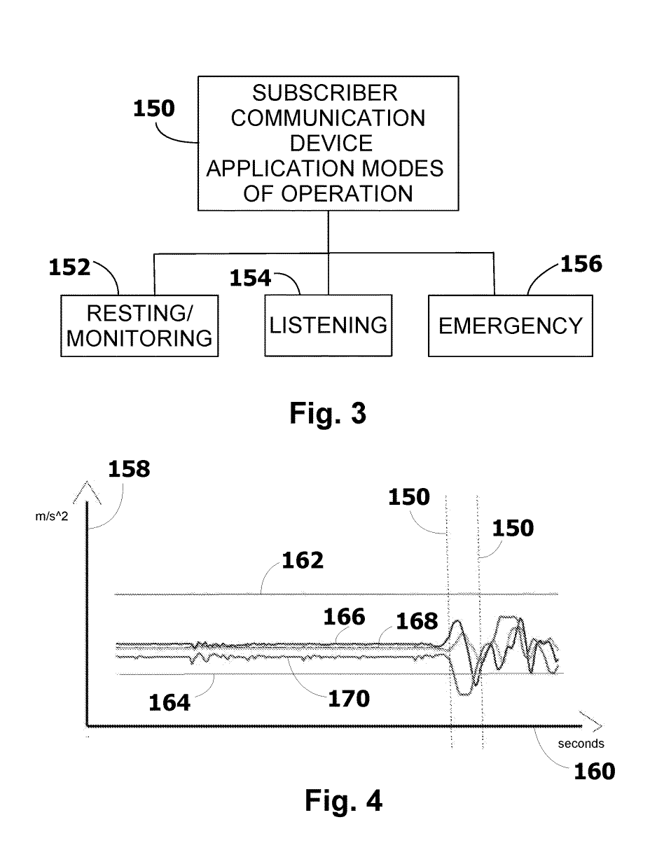

Referring to FIG. 3, in accordance with one embodiment of the present invention the application module of the invention that runs on the subscribed user's communication device 22 can be operated in two or more operation modes, below example of three operation modes 150:

1) Resting/monitoring mode 152: in this mode, the subscriber is not necessarily active. The application of the invention will monitor the sensors of the mobile communication device 22 in the background while other applications of the mobile device 22 will run normally. The application will electrically transfer the sensors data to the server 26 for processing and reporting the data and to identify and categorize abnormal situation of the subscriber. In this mode, the communication device the subscriber 22 (for example, may be referred to as a client in a client-server architecture model) will sample one or more sensors as described above based on a statistic model provided by the server 26 that may be updated daily. The samples graphs will be compared to the statistical models that are also provided by the server 26 and may update daily. Referring to FIG. 4, there is shown an exemplary graph of accelerometer 120 readings received by server 26. The Y-axis 158 designates the acceleration values; the X-axis 160 designates time values in seconds. The client sample monitoring interval in the example is set to every 5 seconds. The statistical model illustrated by a graph is provided by the server 26 and updated daily. Line 162 and line 164 designates upper and lower borders determined by server 26 respectively. Graph 166 designates accelerometer Z-axis values, Graph 168 designates accelerometer X-axis values and Graph 170 designates accelerometer Y-axis values. Vertical rollers 172 and 174 designate the time interval where accelerometer Y-axis and accelerometer Z-axis values are bellow the lower border. In this interval of time between vertical rollers 172 and 174 an abnormal situation may occur.

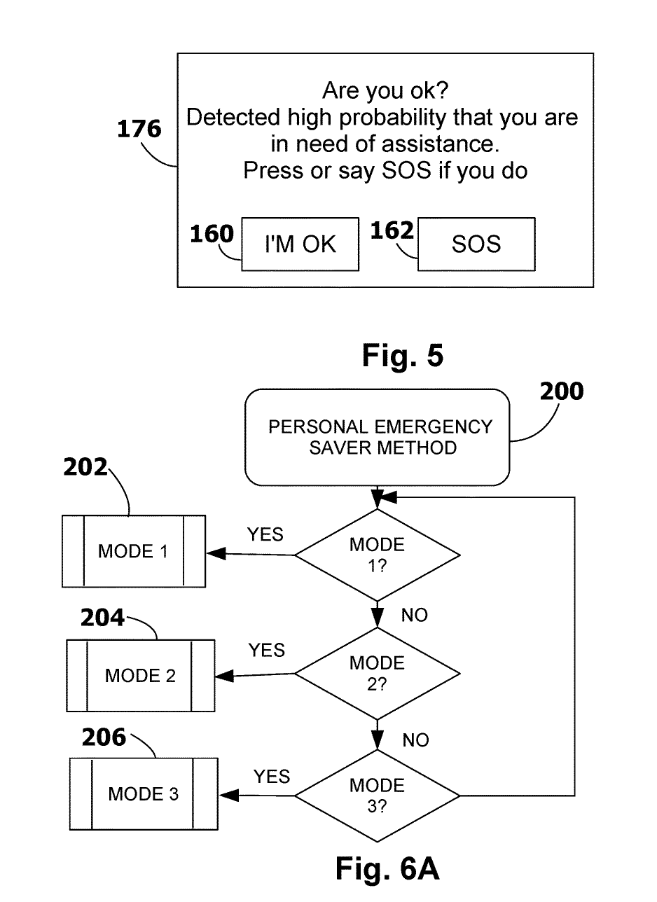

Referring to FIG. 5, in case of abnormal situation a message “Need Help” for example 176 will be displayed on the subscriber communication device display 106 (referring also to FIG. 2). The system and method of the present invention may send to the subscriber other question from a predetermined list of questions depending on a situation. In this mode, a manual report can be triggered for example from the application of the invention in the subscriber's communication device 20. When one of the sensor samples or any combination of sensors is anomalous according to the statistic model(s), the system will prompt to the subscriber with a special prompt message as illustrated in FIG. 5. In case the user presses on the widget “SOS” 162 the system will enter “listening mode” and will route the subscriber to “manual report” view.

In case the user says “SOS” the system will enter “emergency mode”, all data the communication device can gather from more sensors will be gathered and sent to the server 26. In case the user did not reply after a specific interval of time the client will go to “listening mode” and will send the server: the data that caused “Need Help?” which can be front camera snapshot to identify miss click, audio since “Need Help?” popup etc. The server can then decide if it wants to get more info from the client and can send it to the “emergency mode”. The client can optionally turn this feature off In accordance with some embodiments of the present invention the system can use known methods for analyzing voice and sounds coming from the communication device microphone for helping to determine, classified and categorized an emergency situation. For example, if in a real time someone shoots at the subscriber, the system can analyze the sound signal that coming from the microphone of the subscriber's communication device in real time and classified the signal as a gunshot and thus the system immediately enters into an emergency operation mode.

In accordance with another embodiment of the present invention in the resting monitoring mode the subscriber that uses the application of the invention is able to actively report to call-centers 30 about an emergency situation that pressing manually the right widget in the application, a report about the situation will be sent to the server 26. The server 26 will then route the emergency situation to the relevant emergency call-center(s), by adding the subscriber's details, his current location and additional details that can help categorize the emergency situation and provide a full “picture” to the emergency call-center 30. In addition, in some embodiments of the present invention the subscriber of mobile communication device 22 may have the option to report about an emergency situation by an audio recording in any language, preferably, in his mother tongue language. After the recording, the stream audio data can be transmitted to the server 26. Server 26 will analyze the audio content data and the subscriber's voice in order to determine and categorized the type and reliability of the emergency situation by using for example speech to text and sentiment analysis. After analyzing and processing the data, the server 26 will notify the subscriber and the relevant call-center about the emergency situation. In accordance with some embodiments of the present invention the notification about an emergency situation to the relevant emergency call-center 30 can be translated from the subscriber's recorded message, into the local language. This could be useful for example if the subscriber is abroad in a country that doesn't speak his language and he had an accident there. The subscriber 22 can report the emergency situation in his mother tongue language (or text language) and the local emergency call-center will receive the report in the local language. In addition, local call-center representatives can reply to the subscriber in their language (audio and/or text message) through server 26 and the subscriber will receive the reply in his mother tongue language this embodiment of the invention will save time and will be more efficient for helping both the subscriber and the emergency call center(s) to be faster and efficient.

2) Standby/listening mode 154: in this mode, if the system will identify abnormal situation, the system's application will notify the subscriber about an abnormal situation and will activates more sensors and may increase the sampling rate of one or more sensors. The system's application will activate for example the camera and microphone for recording and monitoring and gathering more real time data about the abnormal situation. Then the system will decide, after processing the data from the sensors and audio, video, snapshot pictures media recording and additionally personal characteristics data whether the subscriber is in a real dangerous situation. In order to decide whether the subscriber is in a real dangerous situation the application can monitor the actions taken by the subscriber or the inactivity of the subscriber. In addition, the server 26 will process all the monitored data received from the communication device of the subscriber 22 in order to classify the abnormal situation (for example real situation or false alarm). If there is a real dangerous situation the system 20 will categorize the type of the emergency situation. For example, to decide if the emergency situation is a kidnapping or an accident emergency situation. In a situation where the subscriber doesn't respond, the application will transmit more frequently sensors data, audio and video streaming data to server 26 in order to classify the situation the user is in.

For example, Enter “listening mode” follows after “Need Help?” prompt message. In this mode, the mobile communication device 22 sends to the server 26 “entering listening mode notification” with this data attached: the sensor(s) data that caused the “Need Help?” prompt message. The audio recorded since the “Need Help?” prompt message, and the quick snapshot(s) data of the front camera. The importance of the snapshot: it can assert whether there is a person operating the device or not. Face recognition, can detect miss reports (kids, miss clicks). Face recognition helps analyzing the reporter state of mind by his facial expression. The server 26 connects to the device 22 for example via 2 TCP endpoint and start analyzing the situation, audio only (sensitive to “SOS”) the server 26 then can decide to drop or to deepen the situation analysis. In some cases the server 26 can decide to use the entire communication device 22 sensors and media capabilities.

The (subscriber) user 22 may have at least two ways to return to resting/monitoring mode 152 one by pressing a widget in the application display that everything is OK and the user is in a normal situation. Secondly, the user can say a predetermined word such as “Zooloo” and the system will recognize that the user is in a normal situation and will automatically return to resting/monitoring mode 152. The situations of each subscriber can be recorded in the database of server 26 in order to improve the machine learning and emergency situation recognition model and to reduce false positives errors in data reporting.

3) Emergency mode 156: after an active report of the subscriber that he is in an emergency situation or after the system 20 decides that the user is in an emergency situation, the application will be switched to an emergency mode in which the server 26 will receive continuous or more frequent information from the sensors and media units of the subscriber communication device 22.

The application will record voice messages video streaming and pictures and will update further details about the emergency situation in which the subscriber is in. In addition, the application can enable the subscriber to communicate with the relevant emergency call-center(s) 30 and send to the subscriber the current treatment status of the emergency situation.

The subscriber can trigger an “emergency mode” for example after “Need Help?” is prompt by saying out loud a sound or a word which will be identified and interpreted by the system as a distress signal or by sending high priority fixed report (a familiar situation recognized by key words e.g. “fire”, “kidnapping”, etc.).

In case the communication device of the subscriber is out of reach, the subscriber can also trigger an “emergency mode” by using a button in an external device, e.g. a key chain or a mini remote control (Triggering means”). Said external device then sends a signal via Wi-Fi, Blue tooth, cellular network or Near Field Communication (NFC) containing the subscriber's communication device personal ID and the emergency mode notification to the server(s) 26, in case the subscriber's communication device is out of range for said external device, the signal can be received by communication devices of other subscribers in said external device's range and routed to the server(s), which will then activate “emergency mode” in said subscriber's device, without the involvement of said other subscribers.

In some embodiments of the present invention the server 26 can remotely cause the device 22 to automatically enter an “emergency mode” for example, when a major emergency situation nearby the subscriber's current position, the system can inform the subscriber about the emergency situation so the subscriber will be able choose if to help or to flee from the area. In another exemplary case the server 26 can remotely get device 22 enter into an emergency mode when the server 26 based on the analysis of the data stream it receives from the “listening mode” or in combination with personal data (e.g. personal characteristics) concludes the subscriber is in danger.

Server(s) 26 supports the end users which are: the emergency call-center(s) 30, communication devices of subscribers 22 and may also support the communication devices of non-subscribers 28. The Server(s) 26 is responsible inter alia to route the direct reports that comes to the server(s) 26 from the communication device of subscribers 22, in addition to collecting and storing the data 2 received from the sensors of the subscribers mobile communication devices 22 in a secured manner. If for any reason the subscriber's communication device 22 is unable to communicate with the server 26 a phone call may be instantiated to the local police or to another relevant emergency call-centers 30. On the server side 26 there is an endpoint for each subscriber's report. Fixed report request is an example of reports received by the server from the subscriber which are structured situations, with such reports the server 26 doesn't have to analyze the situation, the server 26 needs only to validate whether the situation is a “false positive” situation or not, and the server 26 has a predetermined scheme to handle each one of the fixed reports. A “false positive” generally refers to in accordance of the present invention as an error in data reporting. Another type of report to be sent to the server from the client is a description of a subscriber where the server 26 needs to interpret the situation out of the user description. In most cases the server can interpret and analyze the situation by machine learning, the server can be “trained” to recognize key words that will match to the fixed reports. But in cases in which the server fails to build a situation, for example because a subscriber didn't describe his situation well enough or the situation is too complicated, the server will try at least to discover the severance of the situation. Another type of report is “entering listening mode” report: when server 26 receives this report it immediately starts analyzing the received data in order to help determine how this report will be handled. For example, at the beginning of the session there is only one stream flowing to server 26 and that is the device microphone 110 live record(s). The server 26 can decide, based on his analysis of the data (and other data such as personal characteristics of the subscriber) and the audio stream, to deepen the data absorption or to drop the request and save the log in server databases. The machine learning unit in the server 26 will have a constant developing algorithm that will be in charge of this process. The algorithm decides what information to save and where, what will be analyzed first and compared to what, and when to classify the situation as an emergency and therefore signal his insights to the right emergency call-centers 30. In addition the machine learning unit before the system entering to an emergency mode of operation and classified and categorize the emergency situation can gather and learn additional information not only from the communication device sensors but also from external databases, the internet, known events and specific properties of the user or subscriber. An example of known event information is when a subscriber or even in the news there was a report about a shooting near the subscriber location or in the area where the subscriber wants to go. An example of specific properties of user/subscriber can be his gender, religion, age, habits etc. Another type of report is the “entering emergency” report: in this case the server 26 only route the user to an emergency call-center 30 and records all the data to a machine learning database.

The server(s) 26 is therefore also responsible to build models in order to predict and to classify abnormal situations of the subscribers 22. Abnormal situations could be personal to the subscriber, geographical (geospatial analysis) and time dependent. The identification and classification of the emergency situation is done in the server(s) 26 automatically and in real time by analyzing and processing the sensors, audio, pictures and video data. The “Need Help?” log endpoint is just for improving the system at prompting “Need Help?” (machine learning false positive).

The system and method of the present invention may further allow an emergency officer to manage the emergency in the most efficient way. It offers full communication with any subscriber the officer chooses, including video in case the user is in need of guidance. It can also allow emergency officer to notify other clients (subscribers or even non-subscribers) about the emergency and route them towards help. The system and method of the present invention can further allow a full responsive map for helping a subscriber which can be synchronized and updated in an emergency situation the officer will have the ability to control the emergency view on any client. Hence, he will be able to reveal the responsive map to a specific user letting him understand the situation much better. The responsive map may include the following elements and entities: situations, emergency mode clients, helping parties or elements clients (ambulance, subscribers/non subscribers, headquarters, nearby safe zones, defibrillators, first aid kits and geographical borders), hospitals, infirmaries, fire hydrants, emergency officer orders and etc.

The software programs in the server and client side include program instructions and data that when loaded in the memory are accessed, executed and used by the processor to carry out method steps described later below, including allowing data and control input from users or the network connection, and creating and displaying an output. The input from the user may be made via any input, including the display, microphone or other input devices or sensors. The input from the user may be obtained from additional sources such as the internet (every day events), public data bases, other subscribers etc.

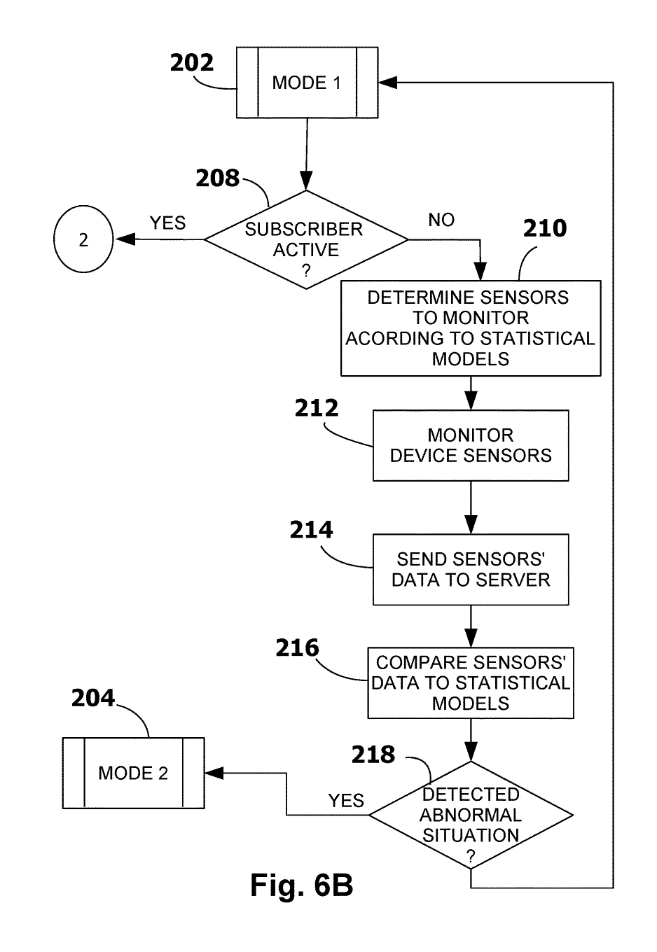

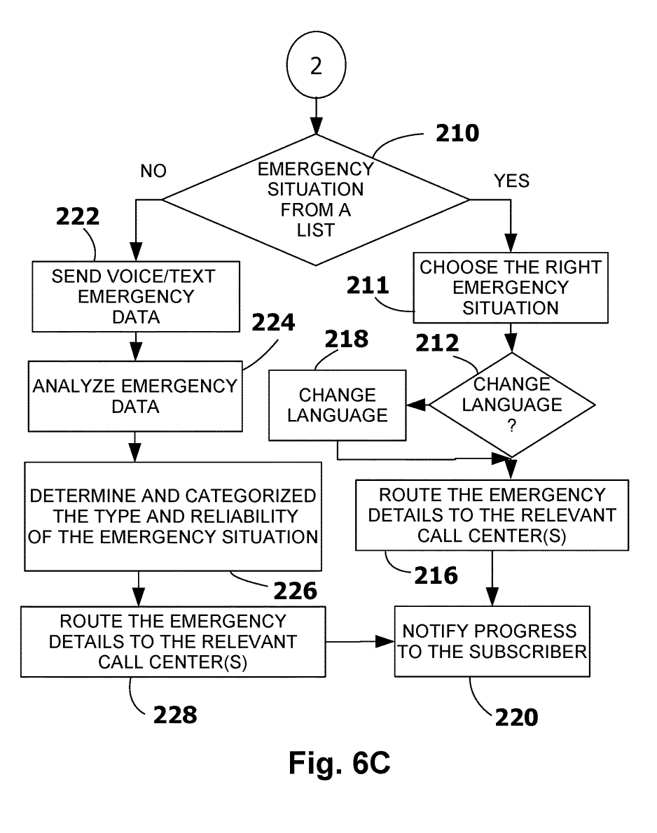

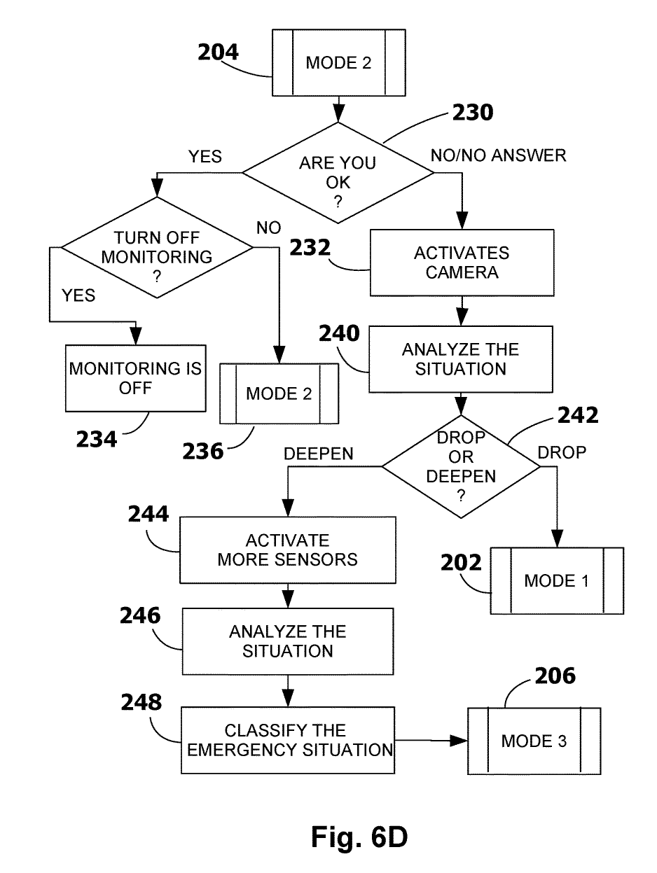

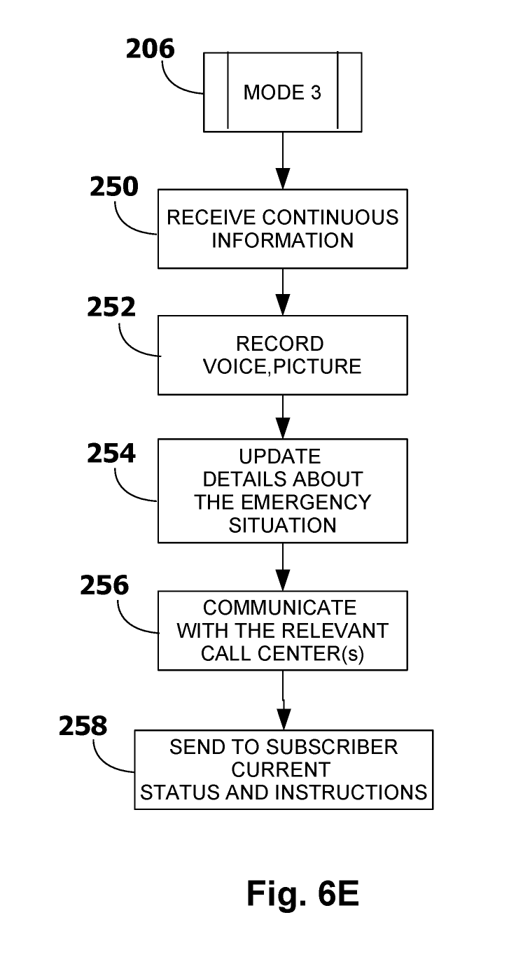

Referring to FIGS. 6A to 6B, there is provided a personal emergency saver method 200 in accordance with some embodiments of the present invention. Mode 1 refers to the resting/monitoring 202, mode 2 refers to the standby/listening mode 204 and mode 3 refers to the emergency mode 206. In step 208 if the subscriber is not active, based on statistic models 210 determined by the server 26 which can be updated daily, one or more sensors provided by the communication device 20 are sampled and monitored 212. In step 214 the sensors' data are sent to server 26 for processing and reporting the data to the server(s) and to identify and categorize abnormal situation(s) of the subscriber. In step 216 the received data is compared with statistical model(s) provided by server 26. In step 218 if detected abnormal situation the system and method of the present invention goes to mode 2. If in step 208 the subscriber is active and he feels that he is in an emergency situation, in step 210 the subscriber can choose his relevant emergency situation by choosing in his communication device 22 from a variety of emergency situations e.g. in the form of a list. After the subscriber chooses 211 his emergency situation from the list of emergency situations, in step 212 before the details about the emergency situation are routed to a call-center (s) in step 216, in step 218 server 26 can sends the details about the emergency situation in any chosen language to the relevant call-center(s) 30 or in the language according to the location of the emergency call-center(s). In step 220 server 26 can notify the subscriber about the current treatment progress regarding his emergency situation. If in step 210 the emergency situation is not chosen by the subscriber from a predetermined list, the subscriber can send a voice and/or text message in step 222 about his emergency situation. Server 26 analyzes in step 224 the received data and classified and categorized the emergency situation in step 226. Another example of an embodiment of the present invention is if a subscriber fell from a cliff, broke his legs and he cannot move. The present invention, regardless of the subscriber's location, enables the subscriber to send a voice message that he fell from a cliff and he needs help. The recorded audio and the sensors readings are sent to the server 26 along with the sensors readings for analysis and process. The server can determine an abnormal situation by analyzing and processing the sensor readings (for example from accelerometer and barometer) and also determine the current physical and or geographical position of the subscriber. As part of the analysis process, the system performs cross-referencing and cross checking of the data received from the sensors with external databases and available big data online, including for example geographical maps, landscape and environment, riots, current local weather, time of day, etc. In addition to the subscriber's personal profile (e.g. the subscriber's nationality, gender, age, behavioral profile etc.). In addition, server 26 analyzes the recorded audio message, for example, predefined key words such as “fall”, “cliff”, “help” to determine and categorize the type of the specific emergency situation that took place. In the above example, the emergency situation occurs and to determine that the emergency situation is, a man falling from a cliff possible injured. In step 228 details about the emergency situation are routed to the relevant call-center(s) 30 for further treatment of the event. In step 204 if the system is in Standby/listening mode, and if the system identifies abnormal situation, the application will notify the subscriber in step 230 about the abnormal situation and for example send a text message to his communication device “Need Help?”/“Close Danger!” if the subscriber replies that he is ok then the subscribes has the option to turn off the monitoring in step 234 or in step 236 to return back to mode 1 in step 202. In step 230 if the subscriber replay that he is not OK or doesn't reply to the message “are you OK?” after a predetermine time, then in step 232 the camera for example in the subscriber's communication device is activated, and streaming data is sent in real time to the server 26 for process and analysis of the situation in step 240. The server 26 then decides in step 242 whether to drop the situation as a result of a false alarm or to deepen the analysis process by remotely activating more sensors more frequently in the subscriber's communication device in step 244 and receiving more raw data to process and help analyze the situation in step 246 in the server 26. In step 248 if a situation is classified as an emergency situation the system and method of the present invention goes to mode 3 in step 206. In step 250 the server receives continuous information from the sensors of the subscriber's communication device. In step 252 voice and pictures (and other sensors) are received by the server 26 recorded and stored in the server's database for further processing and analysis. In step 254 details about the emergency situation are updated and sent to the server 26. In step 256, the server 26 automatically communicates with the relevant call-center(s) and report with details desired suitable language (depending for example on the location of the emergency call-center) about the emergency situation including time and place. In step 258 the server 26 sends automatically to the subscriber the current status and further instructions if needed.

Each of the method steps shown in the figures and described herein may be implemented as a software program that includes program instructions. The program instructions may be executed by a processor, microcontroller, digital signal processor or other device capable of executing program instructions as part of the method. The processor and all or portions of the software may reside on a server, a computer, a mobile device such as a smartphone, or any other device capable of executing program instructions and communicating over a network. The software may be stored and executed at a central location, such as a server, or may be stored and executed in a distributed manner at multiple servers and/or at multiple other devices. The software may, for example, run on a server and interactions by subscriber devices may be via a web browser that interacts with the server. Alternatively, portions of the software may be made available to subscriber devices by a plug-in to a web browser. In still other embodiments of the present invention, portions of the software may be embodied in application programs that run on subscriber devices and devices at the venue that in turn interact with the server and database. Each of the software programs described herein may be stored in a computer usable medium, such as a memory, a hard disk drive, a solid-state or drive, a CD ROM or DVD or on a database or any other type of memory including memory accessible over a network e.g. on a cloud.

One of the objects of the present invention is to automatically categorize an emergency situation of a subscriber based on machine learning, big data analysis, cross checking and cross-referencing sensors data analysis and analyzing semantically words and sentences of the subscriber which could be in a message data or audio data in order to send as much as possible accurate and detailed report about the emergency situation and minimizing false positive reports.

By utilizing the aforementioned capabilities, one of the objects of the present invention is to shorten and minimize the response time of emergency centers, e.g. law enforcement authorities in addition to providing a vast and detailed analysis of the event prior the their arrival and thus increasing the efficiency of potential treatment of the event by said emergency center.

In one embodiment of the present invention the system and method of the present invention enables exchange audio/message information between the subscriber communication device and a call-center regarding to an emergency situation where one side in the communication can send its information in his desired language where the second side receives the exchange audio or message information in his local language. For example, regarding to a certain event that occurred, server 26 receives from communication device(s) 22 data about the event which may include the identities of the people that are involved in the event, the place in which the event took place, sounds and live video streaming from the event from one or more subscribers which can be further analyzed using audio analysis etc., the weather conditions at the event location, the type of the event etc. When server 26 decides in a high probability that there is an emergency situation the server may automatically establish a call-phone with one or more relevant call-center representative. The system and method of the present invention will describe the emergency situation in accordance with the system analysis estimates and in the language that the representative speaks. For example, the call will start with the type of the emergency situation, when it happened, where and who is the one that reported about the emergency situation and the mediating system.

For example the server 26 may send an audio message “This a report about an emergency situation of a car accident in 13 Hashoshanim St. Haifa, Israel at 12:00 PM reported by Jonatan Cohen”. The representative may reply in order to receive more data or in order to acknowledge safe receipt of the report for further handling the emergency situation.

In another embodiment of the present invention the system and method of the present invention enables controlling manually or automatically the sensitivity of the subscriber's protection. For example if a subscriber is hitchhiking he can manually control the sensitivity of the subscriber protection to a higher level of protection by using the application of the invention. When choosing a higher level of protection, the monitoring intervals are shortened, more sensors of the communication device can be activated including voice recording and picture snap-shooting for detecting an emergency situation. Another example for when the level of protection can be increased is when a subscriber is in abroad or when a subscriber is jogging in the streets at night. Another example is when the system and method of the invention detects a dangerous geographical zone; it automatically increases the level of subscriber protection and shortens monitoring intervals.

In another embodiment of the present invention the system and method of the present invention can learn the subscriber behavior by using machine learning for reducing for example false negative of emergency situations.

In another embodiment of the present invention the system and method of the present invention can detect when the subscriber's communication device is being charged. For example, if the subscriber rents a car abroad and he charges the communication device 22 in the rented car, the system and method of the present invention can detect that the user is abroad and also that his communication device is being charged the system may activate more sensors in the communication device 22 without concerning about reducing battery energy and thus increasing user protection.

In another embodiment of the present invention the system and method of the present invention builds a normal behavior model of the user by using machine learning in if the system and method of the present invention abnormal behavior it may detect an emergency situation.

In another embodiment of the present invention the system and method of the present invention builds a normal behavioral model of the user by using machine learning and if the system and method of the present invention detects abnormal behavior of the user, it may conclude it is an emergency situation.

In another embodiment of the present invention, when there is a reported emergency situation, other subscribers 22 near the location of the emergency situation may be notified of said emergency such that they will be able to decide whether to go towards the emergency situation to help (for example in a case of a car accident) or to back away from the place (for example in a case of a terror attack) if said subscribers have decided to go to the location of the emergency situation the system and method of the present invention will guide these subscribers towards the location of the emergency situation. If subscribers have decided to back away from the location of the emergency situation, the system and method of the present invention will guide the subscribers to a safe place. The system guidance can be visual on a map application and with audio instructions. The guidance may utilize the mobile communication sensors in order to decide also in real time what is the current subscriber direction of movement.

Yet in accordance with another embodiment of the present invention, if there is an emergency situation, for example a child is lost in a shopping center. The system and method of the present invention can scan for other subscribers that are currently in the shopping center or that are in a predetermined radius from the place where the emergency situation is occurring. The system and method of the present invention can send a picture of the lost child or other relevant details to nearby subscribers through the application of the invention. Every subscriber that will decide to help finding the lost child will be able to scan the area and the server 26 will receive the data regarding the areas that are already being scanned including the direction of the subscriber's movement. In addition, the subscribers that are helping with finding the lost child may see on their communication device displays the areas that are already being or have been scanned already by other subscribers.

In accordance with another embodiment of the present invention said communication device includes a physical push button or other physical means such as but not limited to shaking the communication device for activating the application of the invention and activating sensors which may include voice and camera or for entering immediately into emergency mode. The data from these sensors will be sent from the communication device to the server 26 for further processing for identifying if an emergency situation occurs.

It should be understood that the above description is merely exemplary and that there are various embodiments of the present invention that may be devised, mutatis mutandis, and that the features described in the above-described embodiments, and those not described herein, may be used separately or in any suitable combination; and the invention can be devised in accordance with embodiments not necessarily described above.

1. A system for helping at least one subscriber in at least one emergency situation comprising:
at least one server communicatively connected to at least one communication network;
at least one wireless mobile communication device of a subscriber having at least one sensor means, said wireless mobile communication device is communicatively connected through said communication network(s) with said server(s);
at least one call-center to communicate with said server(s) and said mobile communication device(s);
wherein, said server(s) communicatively connected with said communication device(s) for identifying passively and automatically an abnormal and/or an emergency situation regarding to a subscriber without the involvement of said subscriber, said server(s) further automatically contacts the relevant emergency call-center(s) for helping said subscriber when an emergency situation is identified.

2. A system for helping at least one subscriber in at least one kind of emergency situations according to claim 1, wherein said server further automatically categorizes an emergency situation of a subscriber by using data received from said at least one sensor means, using a machine learning unit and by analyzing semantically words and sentences received in said server(s) from said subscriber's communication device which could be in the form of a message data or audio data in order to send an accurate and detailed report to the relevant call center(s) about the emergency situation and minimizing false positive reports.

3. A system for helping at least one subscriber in at least one emergency situation according to claim 2, wherein said emergency call-center(s) receive from said server(s) the present situation of the subscriber regarding to an abnormal event category and receives a real time report through said server(s) about said subscriber and said emergency situation.

4. A system for helping at least one subscriber in at least one emergency situation according to claim 2, wherein said server exchange audio or message information between said subscriber's communication device and a call-center through said server(s) regarding to an emergency situation where one side in the communication can send its information in his desired language and where the second side receives the exchange audio or message information in his local language.

5. A system for helping at least one subscriber in at least one emergency situation according to claim 1, wherein the sensitivity protection of said subscriber can be controlled manually in said mobile communication device by said subscriber or automatically.

6. A system for helping at least one subscriber in at least one emergency situation according to claim 1, wherein said wireless mobile communication device(s) of subscriber(s) is selected from a group of Smart phones, Tablets and Smart watches and is communicatively connected through at least one communication network to said server(s).

7. A system for helping at least one subscriber in at least one emergency situation according to claim 1, wherein said at least one sensor means is selected from a group of a display, a speaker, a microphone, a heart rate sensor, finger print sensor, gyroscope(s), barometric pressure sensor, ambient pressure sensor, UV sensor, oxymetry sensor, skin conductance sensor, skin temperature sensor, accelerometer(s), temperature or humidity sensor, GPS and magnetometer.

8. A system for helping at least one subscriber in at least one emergency situation according to claim 1, wherein an open communication line is automatically opened between said subscriber's communication device and a relevant emergency call center(s) in an emergency situation.

9. A system for helping at least one subscriber in at least one emergency situation according to claim 1, wherein said system further comprising at least one wireless mobile communication device carried by at least one nonsubscriber to communicate automatically with said server and said subscriber's communication device in an emergency situation.

10. A system for helping at least one subscriber in at least one emergency situation according to claim 1, wherein an application module that runs on said subscribed user communication device having at least two operational modes.

11. A system for helping at least one subscriber in at least one emergency situation according to claim 1, wherein an application module that runs on said subscribed user communication device having three operation modes: resting/monitoring mode, standby/listening mode and emergency mode; said operation modes can be selected automatically or manually.

12. A system for helping at least one subscriber in at least one emergency situation according to claim 11, wherein in said resting/monitoring mode, the communication device of said subscriber samples one or more of said sensors based on a statistic model provided by said server; said statistical model can be updated daily; the samples graphs are compared with the statistical models that are also provided by said server, which may be updated from time to time, to detect abnormal situations.

13. A system for helping at least one subscriber in at least one emergency situation according to claim 2, wherein said server remotely cause at least one of said communication devices to get automatically into an emergency mode when an emergency situation nearby the subscriber current position is detected and can further inform the subscriber about the emergency situation so the subscriber that is near the emergency situation will be able choose whether to get closer or flee from the area.

14. A system for helping at least one subscriber in at least one emergency situation according to claim 2, wherein in case of an emergency situation of a certain subscriber, said server can scan the area for other subscribers in the subscriber's proximity in a predetermined radius from the location of the emergency situation which occurred, said server may send a guiding information to said subscribers in said area for helping said subscriber in said emergency situation.

15. A system for helping at least one subscriber in at least one emergency situation according to claim 14, wherein the communication device of every subscriber that will decide to help said subscriber in said emergency situation, will automatically and/or manually send a real time report to said server(s) about its current helping status and other relevant data.

16. A system for helping at least one subscriber in at least one emergency situation according to claim 11, wherein said subscriber can remotely trigger said “emergency mode” by using triggering means.

17. A method for helping at least one subscriber in at least one emergency situation, said subscriber having a mobile communication device communicatively connected with at least one server and communicatively connected with at least one call-center, said method comprising the steps of:
determining by said server based on statistical models one or more sensors provided by the communication device to be sampled and monitored;
sampling and monitoring said one or more sensors and sending the data received from said sensors to said server(s);
comparing with said statistical model(s) provided by said server said received data for identifying and categorizing abnormal situation(s);
choosing in said communication device the right emergency situation from a list when said subscriber is active and in emergency situation and sending said chosen emergency situation with other relevant data to said server; and
sending the details about said emergency situation to the relevant call-center(s) by voice and/or text.

18. A method for helping at least one subscriber in at least one emergency situation according to claim 17, further comprising the step of sending the details about the emergency situation in any chosen language to the relevant call-center(s) by voice and/or text and wherein said call-center(s) receive the details about said emergency situation in the local language of said call-center(s).

19. A method for helping at least one subscriber in at least one emergency situation according to claim 17, further comprising the steps of sending a voice and/or text message about said subscriber's emergency situation to said server when said emergency situation is not chosen by said subscriber from a predetermined list; analyzing, classifying and categorizing said data to determine the current emergency situation.

20. A method for helping at least one subscriber in at least one emergency situation according to claim 17, further comprising the step of notifying said subscriber the current progress of treatment regarding to his emergency situation.

21. A method for helping at least one subscriber in at least one emergency situation according to claim 17, further comprising the steps of entering automatically into an emergency mode when an emergency situation nearby the subscriber's current position is detected and informing said subscriber about said emergency situation so the subscriber that is near the emergency situation will be able to choose whether to get closer or flee from said emergency situation's area.

22. A method for helping at least one subscriber in at least one emergency situation according to claim 17, further comprising the step of providing online responsive map for helping a subscriber which can be synchronized and updated in an emergency situation, controlled either by said subscriber and/or by said call center.
